(19) United States
(12) Patent Application Publication
(10) Pub. No.: US 2021/0360876 A1
(43) Pub. Date: Nov. 25, 2021

(54) WEED AND GRASS BARRIER SYSTEM

(71) Applicant: David Cacioppo, Leawood, KS (US)

(72) Inventor: David Cacioppo, Leawood, KS (US)

(21) Appl. No.: 17/211,908

(22) Filed: Mar. 25, 2021

Related U.S. Application Data
(60) Provisional application No. 63/028,002, filed on May 21, 2020.

(51) Int. Cl. A01G 9/28

(52) U.S. Cl. CPC A01G 9/28

(57) ABSTRACT

A barrier system to be installed on a ground surface for keeping unwanted vegetation from growing across a boundary comprises a first end stake, a second end stake, a plurality of inner stakes, and a cover. Each stake includes generally horizontally-oriented cap and a generally vertically-oriented anchor attached to the cap. The cover includes a channel, a top wall, a first side wall attached to one side of the top wall, and a second side wall attached to the other side of the top wall. The first end stake is configured to be positioned in the channel at a first end of the cover, the second end stake is configured to be positioned in the channel at a second end of the cover, and the inner stakes are configured to be positioned in the channel in between the first end of the cover and the second end of the cover.

### RELATED APPLICATIONS

The current patent application is a regular utility patent application which claims priority benefit, with regard to all common subject matter, to U.S. Provisional Application Ser. No. 63/028,002, entitled “WEED AND GRASS BARRIER SYSTEM”, filed May 21, 2020. The listed application is hereby incorporated by reference, in its entirety, into the current patent application.

### FIELD OF THE INVENTION

Embodiments of the current invention relate to systems that provide a barrier to the growth of unwanted vegetation in lawn and/or garden areas.

### BACKGROUND

Weed and grass barriers are often utilized to prevent vegetation, such as weeds and grass, from growing directly under or adjacent to fences or in other areas of a lawn and/or garden.

### SUMMARY OF THE INVENTION

Embodiments of the current invention provide a distinct advance in the art of weed and grass barriers. Specifically, embodiments of the current invention may provide a weed and grass barrier system that includes features which prevent lateral migration and upward migration of the barrier unit once it is installed in the ground.

The barrier system broadly comprises a first end stake, a second end stake, a plurality of inner stakes, and a cover. Each stake includes a generally horizontally-oriented cap and a generally vertically-oriented anchor attached to the cap. The anchor is configured to be inserted into the ground surface and includes a plurality of side protrusions extending outward from the anchor for preventing upward migration of the barrier unit when the barrier unit is installed on the ground surface. The cover includes a top wall, a channel, a first side wall, and a second side wall. The top wall is generally horizontally-oriented. The channel is positioned on a lower surface of the top wall and configured to receive the cap of the stake. The first side wall is generally vertically-oriented and attached to a first side edge of the top wall. The second side wall is generally vertically-oriented and attached to an opposing second side edge of the top wall. The first side wall and the second side wall each include a lower edge configured to penetrate the ground surface when the barrier unit is installed on the ground surface. The first end stake is configured to be positioned in the channel at a first end of the cover. The second end stake is configured to be positioned in the channel at a second end of the cover. The inner stakes are configured to be positioned in the channel in between the first end of the cover and the second end of the cover.

Another embodiment of the current invention provides a barrier system that comprises a first end stake, a second end stake, a plurality of inner stakes, and a cover. Each stake includes a generally horizontally-oriented cap and a generally vertically-oriented anchor attached to the cap. The anchor is configured to be inserted into the ground surface and includes a plurality of side protrusions extending outward from the anchor for preventing upward migration of the barrier unit when the barrier unit is installed on the ground surface. The cover includes a top wall, a channel, a first side wall, and a second side wall. The top wall is generally horizontally-oriented. The channel is positioned on a lower surface of the top wall and configured to receive the cap of the stake. The first side wall is generally vertically-oriented and attached to a first side edge of the top wall. The second side wall is generally vertically-oriented and attached to an opposing second side edge of the top wall. The first side wall and the second side wall each include a lower edge configured to penetrate the ground surface when the barrier unit is installed on the ground surface. The first end stake is configured to be positioned in the channel with an end roughly aligned with a first end of the cover. The second end stake is configured to be positioned in the channel with an end roughly aligned with a second end of the cover. The inner stakes are configured to be positioned in the channel and spaced apart from one another between the first end of the cover and the second end of the cover.

Yet another embodiment of the current invention provides a barrier system that also comprises a first end stake, a second end stake, a plurality of inner stakes, and a cover. Each stake includes a generally horizontally-oriented cap and a generally vertically-oriented anchor attached to the cap. The anchor is configured to be inserted into the ground surface and includes a plurality of side protrusions extending outward from the anchor for preventing upward migration of the barrier unit when the barrier unit is installed on the ground surface. The cover includes a top wall, a channel, a first side wall, and a second side wall. The top wall is generally horizontally-oriented. The channel is positioned on a lower surface of the top wall and configured to receive the cap of the stake. The first side wall is generally vertically-oriented and attached to a first side edge of the top wall. The second side wall is generally vertically-oriented and attached to an opposing second side edge of the top wall. The first side wall and the second side wall each include a lower edge configured to penetrate the ground surface when the barrier unit is installed on the ground surface. The first end stake is configured to be positioned in the channel with an end roughly aligned with a first end of the cover. The second end stake is configured to be positioned in the channel with an end roughly aligned with a second end of the cover. The inner stakes are configured to be positioned in the channel with an axial center of one inner stake spaced apart approximately one foot from an axial center of an adjacent stake between the first end of the cover and the second end of the cover.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is an upper perspective view of a weed and grass barrier system, constructed in accordance with various embodiments of the invention, the barrier system comprising a first end stake, a second end stake, a plurality of inner stakes, and a cover;

FIG. 2 is a lower perspective view of the weed and grass barrier system;

FIG. 3 is an upper perspective view of a stake;

FIG. 4 is a lower perspective view of the stake;

FIG. 5 is an upper perspective view of a cover;

FIG. 6 is an end view of the barrier system installed in the ground;

FIG. 7 is an environmental view of another embodiment of a weed and grass barrier system installed in a lawn and/or garden setting, the barrier system comprising a plurality of barrier units;

FIG. 8 is an upper perspective view of the barrier unit;

FIG. 9 is a lower perspective view of the barrier unit;

FIG. 10 is an upper perspective view of a stake of the barrier unit;

FIG. 11 is a lower perspective view of the stake;

FIG. 12 is an upper perspective view of a cover of the barrier unit;

FIG. 13 is an end view of the barrier unit installed in the ground;

FIG. 14 is an upper perspective view of an alternative embodiment of the barrier system, wherein the covers are offset from the stakes;

FIG. 15 is a side view of the alternative embodiment of the barrier system; and

FIG. 16 is an upper perspective view of another embodiment of the barrier unit.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

Relational terms, such as “above”, “below”, “upper”, “upward”, “downward”, “lower”, “top”, “bottom”, “outer”, “inner”, etc., may be used throughout this description. These terms are used with reference to embodiments of the technology and the orientations thereof shown in the accompanying figures. Embodiments of the technology may be oriented in other ways. Therefore, the terms do not limit the scope of the present technology.

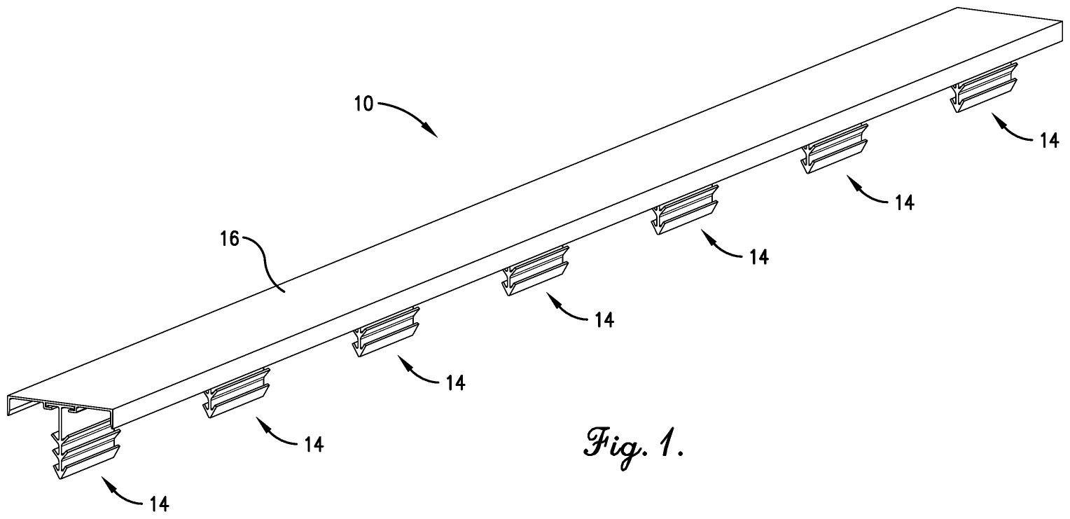

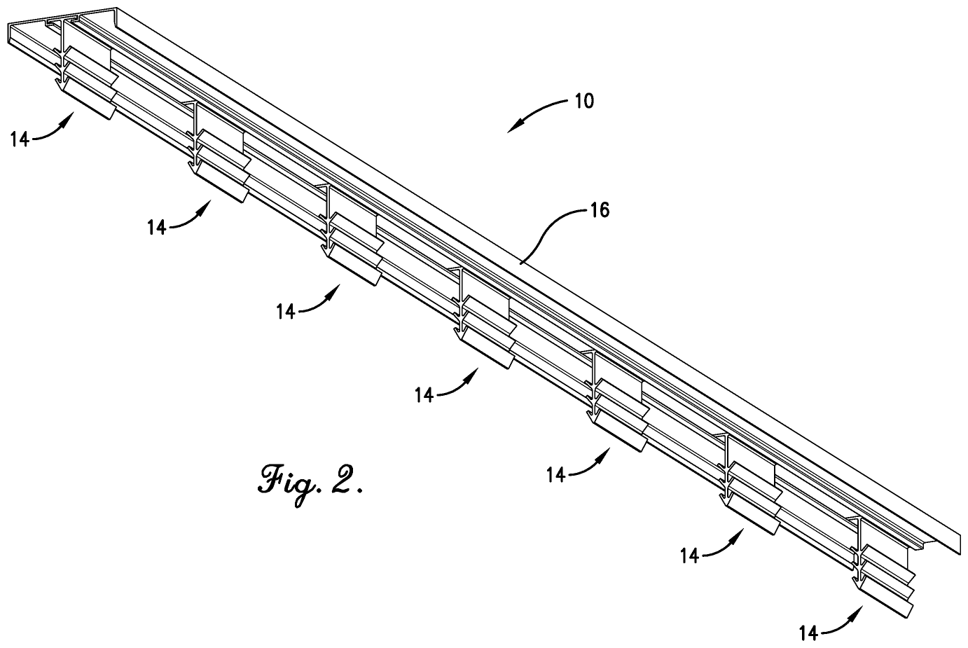

Referring to FIGS. 1 and 2, a weed and grass barrier system 10, constructed in accordance with various embodiments of the current invention, configured to keep unwanted vegetation from growing across a boundary is shown. The barrier system 10 broadly comprises a plurality of stakes 14 and one or more covers 16. The barrier system 10 may be utilized along fence lines, garden boundaries, rock walls, retaining walls, driveways, sidewalks, and the like generally to prevent vegetation from growing from one side of the barrier system 10 to the other side.

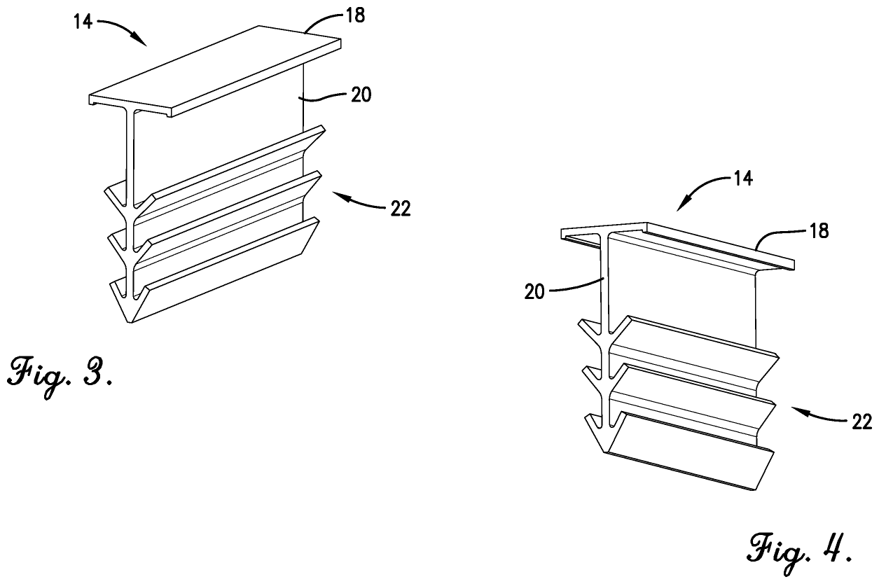

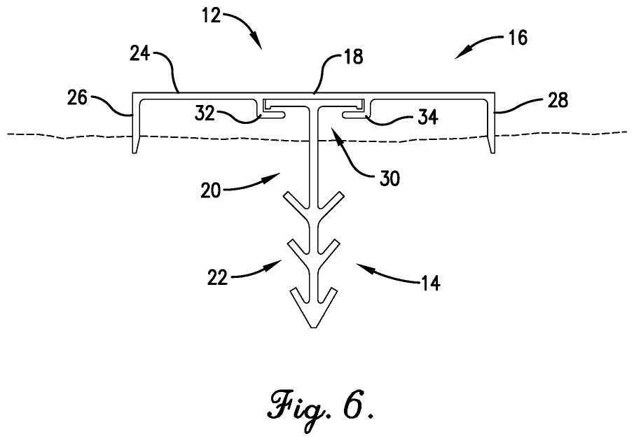

Each stake 14, shown in FIGS. 1-4 and 6, includes a cap 18 and an anchor 20. The cap 18 has a generally quadrilateral shape with a relatively small thickness and a length that is greater than its width. The cap 18 has an upper surface, an opposing lower surface, first and second opposing side surfaces positioned along the length, and first and second opposing end surfaces positioned along the width. Typically, the cap 18 is oriented on a horizontal plane. In various embodiments, the cap 18 includes a first flange and a second flange each positioned along opposing sides of the lower surface and extending away therefrom, or in a downward direction. An exemplary cap 18 has a width of approximately 1.2 inches and a thickness of approximately 0.09 inches. The first and second flange may extend downward from the lower surface approximately 0.03 inches.

The anchor 20 has a generally quadrilateral shape with a relatively small thickness and a length that is greater than its height. The anchor 20 has an upper edge that is coupled to the cap 18 along a lengthwise centerline of the lower surface of the cap 18. Thus, the anchor 20 is typically oriented along a vertical plane. The anchor 20 also has a lower edge, first and second opposing side surfaces positioned along the length, and first and second opposing end surfaces positioned along the height. In addition, the anchor 20 includes a plurality of side protrusions 22 coupled thereto. The side protrusions 22 are distributed along the first and second side surfaces and extend outward therefrom. In exemplary embodiments, the side protrusions 22 includes pairs of upward pointing spikes that are spaced apart from one another along the height of the anchor 20, with each spike extending the length of the anchor 20. A first spike of each pair is positioned on the first side surface, and a second spike of each pair is positioned on the second side surface in alignment with the first spike. For example, the side protrusions 22 include a first pair of spikes with a first spike coupled to the lower edge of the anchor 20 and extending outward and upward from the first side surface and a second spike coupled to the lower edge of the anchor 20 and extending outward and upward from the second side surface. The side protrusions 22 include a second pair of spikes that are positioned above the first pair of spikes with a third spike coupled to the first side surface and extending outward and upward therefrom and a fourth spike coupled to the second side surface and extending outward and upward therefrom. The side protrusions 22 include a third pair of spikes that are positioned above the second pair of spikes with a fifth spike coupled to the first side surface and extending outward and upward therefrom and a sixth spike coupled to the second side surface and extending outward and upward therefrom. The spikes are coupled to the anchor 20 to form an upward angle with respect the to side surfaces that increases with each successive pair. For example, each spike of the first pair of spikes forms an angle with its respective side surface of approximately 30 degrees. Each spike of the second pair of spikes forms an angle with its respective side surface of approximately 40 degrees. Each spike of the third pair of spikes forms an angle with its respective side surface of approximately 45 degrees.

The anchor 20 has a thickness of approximately 0.106 inches. Each spike has a thickness of approximately 0.085 inches. The anchor 20 in combination with the cap 18 gives the stake 14 a height of approximately 2.84 inches. The length of the stake 14 ranges from approximately 3 inches to approximately 4 inches. All of the dimensions are exemplary and may be varied while still remaining within the scope of the current invention.

The stake 14 may be formed from flexible or rigid polymers or similar materials. The cap 18 and the anchor 20 may be monolithically or integrally formed. Or, the cap 18 and the anchor 20 may be separately formed and joined together.

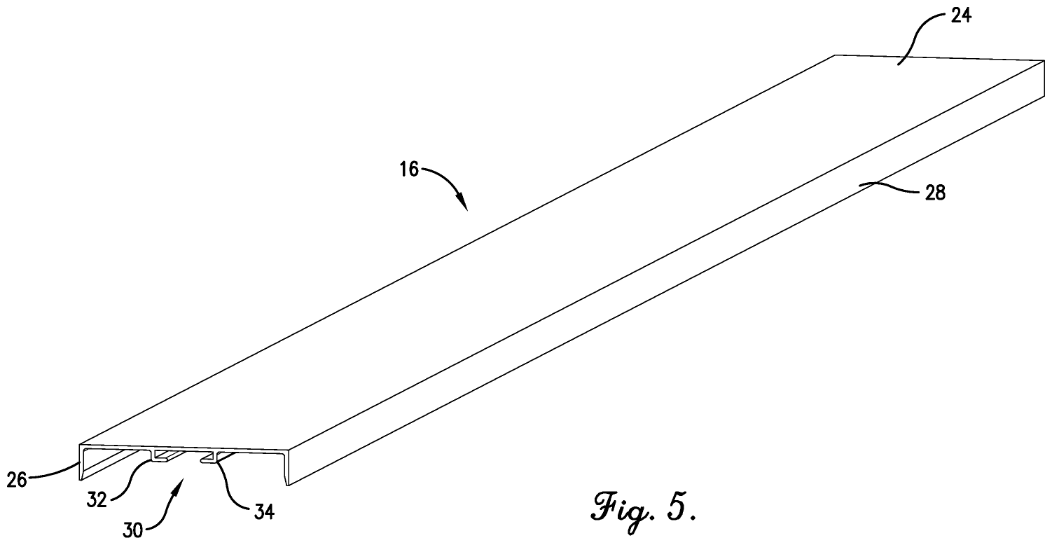

The cover 16, shown in FIGS. 1, 2, 5, and 6, includes a top wall 24, a first side wall 26, a second side wall 28, and a channel 30. The top wall 24 has a generally quadrilateral shape with a relatively small thickness. The top wall 24 includes an upper surface, an opposing lower surface, first and second opposing end surfaces, and first and second side edges. The first side wall 26 is coupled to the top wall 24 along the first side edge, and the second side wall 28 is coupled to the top wall 24 along the second side edge. A lower edge of each side wall 26, 28 is typically beveled to provide easier penetration of the ground. The channel 30 is formed on the lower surface of the top wall 24 by a first flange 32 and a spaced apart second flange 34 attached to the lower surface, wherein each flange 32, 34 includes a vertical member extending downward from the lower surface and a horizontal member attached to the vertical member and extending inward toward a centerline of the top wall 24. The cover 16 has a thickness of approximately 0.08 inches, a width from the first side wall 26 to the second side wall 28 of approximately 4.5 inches. The first side wall 26 and the second side wall 28 each extend downward from the top wall 24 approximately 0.63 inches. The channel 30 has a width of approximately 1.25 inches and a depth of approximately 0.156 inches, which accommodate the width and the thickness, respectively, of the cap 18. The cover 16 has a length from end to end of at least 6 feet with other embodiments being longer, for example, 9 feet, 12 feet, etc. The cover may be formed from polymers or other materials that are rigid along a horizontal plane, but are flexible along a vertical plane.

One or more surfaces of the stake 14 and/or the cover 16 may be coated with an herbicide to resist growth of vegetation over the cover 16. In addition, the upper surface of the top wall 24 of the cover 16 may include images or patterns that depict rocks, grass, soil, mulch, or other objects.

In usage, the barrier system 10 is formed by inserting the caps 18 of a plurality of stakes 14 into the channel of one cover 16. Typically, a first end stake 14 and a second end stake 14 are positioned roughly aligned with opposing ends of the cover 16, and a plurality of inner stakes 14 positioned therebetween. That is, an axial center of each inner stake 14 may be positioned at approximately every foot along the length of the cover 16. For example, with a six-foot cover 16, the first end stake 14 is positioned at one end of the cover 16 with one end of the first end stake 14 aligned with one end of the cover 16, five inner stakes 14 are positioned along the length of the cover 16 spaced approximately one foot apart and centered at approximately the 1-foot point through approximately the 5-feet point, and the second end stake 14 is positioned at the opposing end of the cover 16 with one end of the second end stake 14 aligned with the opposing end of the cover 16. The inner stakes 14 are spaced apart from one another because it is not necessary for the inner stakes 14 to abut one another to provide adequate support and bracing for the cover 16. Spacing of approximately one foot between centers saves cost, materials, and labor in creating the barrier system 10 while also providing support and enough stakes 14 to prevent the cover 16 from migrating. Once the barrier system 10 is assembled, it may be installed on the ground surface by inserting the lower edge of each of the stakes 14 into the ground and applying downward pressure to the cover 16 at the location of each stake 14. Additional covers 16, with accompanying stakes 14, may be utilized in the barrier system 10. Each additional cover 16 and stakes 14 are assembled as discussed above and installed on the ground surface adjacent to an already installed cover 16, such that one end of one cover 16 abuts, or nearly abuts, one end of an adjacent cover 16.

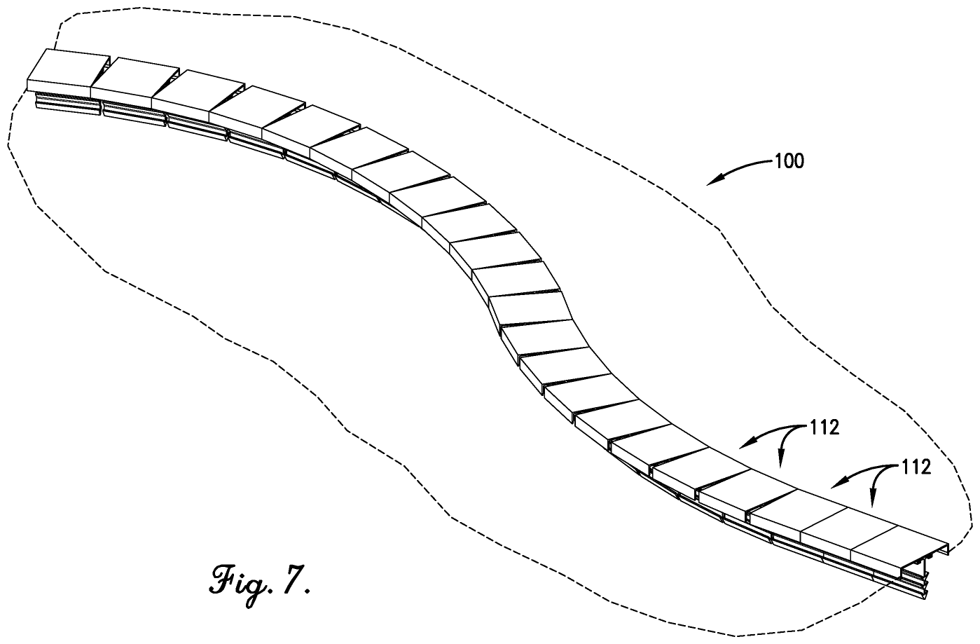

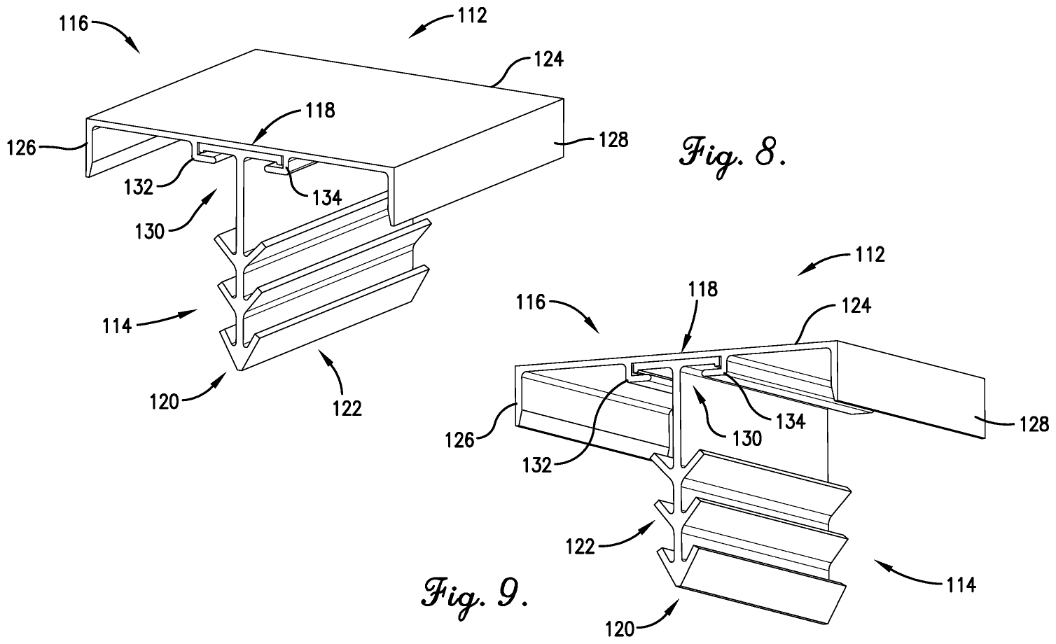

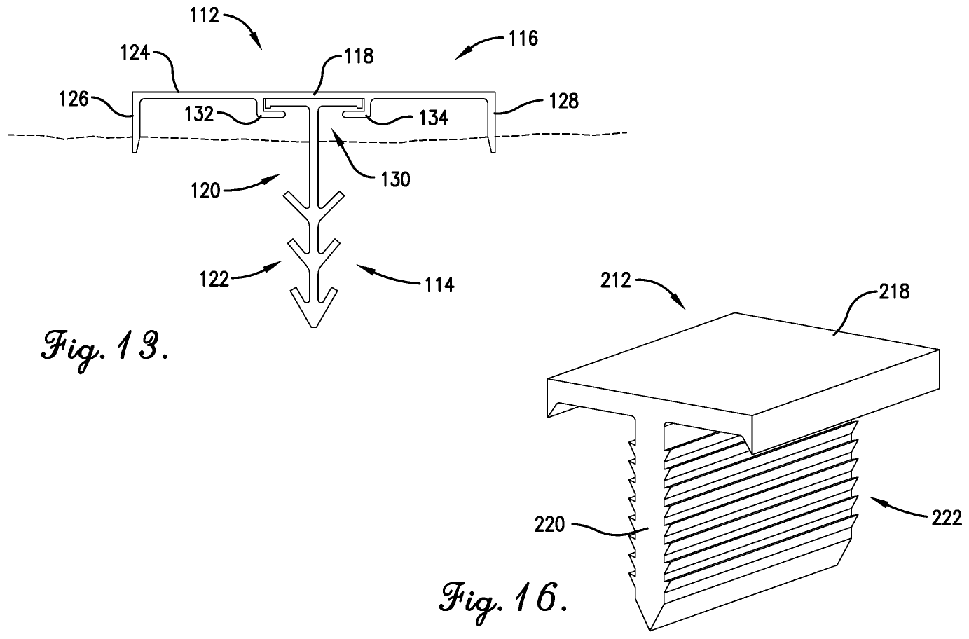

Referring to FIGS. 7, 14, and 15, another embodiment of the weed and grass barrier system 100, constructed in accordance with various embodiments of the current invention, configured to keep unwanted vegetation from growing across a boundary is shown. The barrier system 100 broadly comprises a plurality of barrier units 112, with each barrier unit 112 including a stake 114 and a cover 116, as shown in FIGS. 7-9 and 13. The barrier system 100 may be utilized along fence lines, garden boundaries, rock walls, retaining walls, driveways, sidewalks, and the like generally to prevent vegetation from growing from one side of the barrier system 100 to the other side.

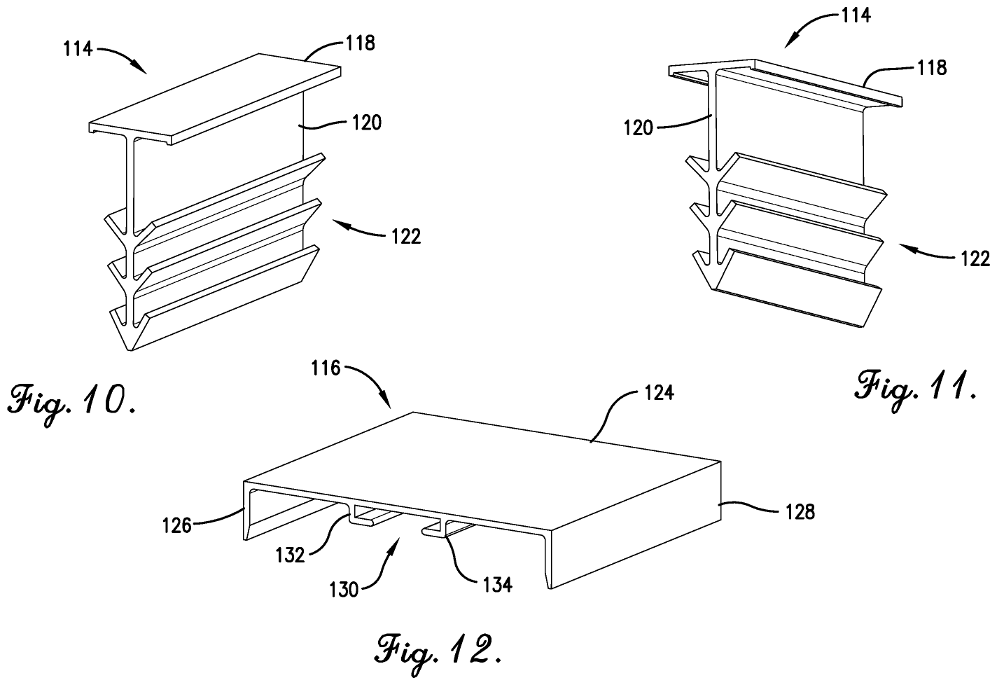

The stake 114, shown in FIGS. 7-11 and 13, includes a cap 118 and an anchor 120. The cap 118 has a generally quadrilateral shape with a relatively small thickness and a length that is greater than its width. The cap 118 has an upper surface, an opposing lower surface, first and second opposing side surfaces positioned along the length, and first and second opposing end surfaces positioned along the width. Typically, the cap 118 is oriented on a horizontal plane. In various embodiments, the cap 118 includes a first flange and a second flange each positioned along opposing sides of the lower surface and extending away therefrom, or in a downward direction. An exemplary cap 118 has a width of approximately 1.2 inches and a thickness of approximately 0.09 inches. The first and second flange may extend downward from the lower surface approximately 0.03 inches.

The anchor 120 has a generally quadrilateral shape with a relatively small thickness and a length that is greater than its height. The anchor 120 has an upper edge that is coupled to the cap 118 along a lengthwise centerline of the lower surface of the cap 118. Thus, the anchor 120 is typically oriented along a vertical plane. The anchor 120 also has a lower edge, first and second opposing side surfaces positioned along the length, and first and second opposing end surfaces positioned along the height. In addition, the anchor 120 includes a plurality of side protrusions 122 coupled thereto. The side protrusions 122 are distributed along the first and second side surfaces and extend outward therefrom. In exemplary embodiments, the side protrusions 122 includes pairs of upward pointing spikes that are spaced apart from one another along the height of the anchor 120, with each spike extending the length of the anchor 120. A first spike of each pair is positioned on the first side surface, and a second spike of each pair is positioned on the second side surface in alignment with the first spike. For example, the side protrusions 122 include a first pair of spikes with a first spike coupled to the lower edge of the anchor 120 and extending outward and upward from the first side surface and a second spike coupled to the lower edge of the anchor 120 and extending outward and upward from the second side surface. The side protrusions 122 include a second pair of spikes that are positioned above the first pair of spikes with a third spike coupled to the first side surface and extending outward and upward therefrom and a fourth spike coupled to the second side surface and extending outward and upward therefrom. The side protrusions 122 include a third pair of spikes that are positioned above the second pair of spikes with a fifth spike coupled to the first side surface and extending outward and upward therefrom and a sixth spike coupled to the second side surface and extending outward and upward therefrom. The spikes are coupled to the anchor 120 to form an upward angle with respect the to side surfaces that increases with each successive pair. For example, each spike of the first pair of spikes forms an angle with its respective side surface of approximately 30 degrees. Each spike of the second pair of spikes forms an angle with its respective side surface of approximately 40 degrees. Each spike of the third pair of spikes forms an angle with its respective side surface of approximately 45 degrees.

The anchor 120 has a thickness of approximately 0.106 inches. Each spike has a thickness of approximately 0.085 inches. The anchor 120 in combination with the cap 118 gives the stake 114 a height of approximately 2.84 inches. The length of the stake 114 ranges from approximately 3 inches to approximately 4 inches. All of the dimensions are exemplary and may be varied while still remaining within the scope of the current invention.

The stake 114 may be formed from flexible polymers or similar flexible materials. The cap 118 and the anchor 120 may be monolithically or integrally formed. Or, the cap 118 and the anchor 120 may be separately formed and joined together.

The cover 116, shown in FIGS. 7-9, 12, and 13, includes a top wall 124, a first side wall 126, a second side wall 128, and a channel 130. The top wall 124 has a generally quadrilateral shape with a relatively small thickness. The top wall 124 includes an upper surface, an opposing lower surface, first and second opposing end surfaces, and first and second side edges. The first side wall 126 is coupled to the top wall 124 along the first side edge, and the second side wall 128 is coupled to the top wall 124 along the second side edge. A lower edge of each side wall 126, 128 is typically beveled to provide easier penetration of the ground. The channel 130 is formed on the lower surface of the top wall 124 by a first flange 132 and a spaced apart second flange 134 attached to the lower surface, wherein each flange 132, 134 includes a vertical member extending downward from the lower surface and a horizontal member attached to the vertical member and extending inward toward a centerline of the top wall 124. The cover 116 has a thickness of approximately 0.08 inches, a width from the first side wall 126 to the second side wall 128 of approximately 4.5 inches, and a length from end to end ranging from approximately 3 inches to approximately 4 inches. The first side wall 126 and the second side wall 128 each extend downward from the top wall 124 approximately 0.63 inches. The channel 130 has a width of approximately 1.25 inches and a depth of approximately 0.156 inches, which accommodate the width and the thickness, respectively, of the cap 118.

One or more surfaces of the barrier unit 112 may be coated with an herbicide to resist growth of vegetation over the cover 116. In addition, the upper surface of the top wall 124 of the cover 116 may include images or patterns that depict rocks, grass, soil, mulch, or other objects.

In usage, the barrier unit 112 may be assembled by sliding or inserting the cap 118 of the stake 114 into the channel 130 of the cover 116. The barrier unit 112 may then be installed by inserting the lower edge of the anchor 120 into the ground and pushing downward on the cover 116. The barrier unit 112 may be pushed into the ground until the lower edges of the first side wall 126 and the second side wall 128 penetrate the ground, as shown in FIG. 7. Once installed, the side protrusions 122 of the anchor 120 prevent upward migration of the barrier unit 112, while the first side wall 126 and the second side wall 128 prevent lateral migration.

A plurality of barrier units 112 may be placed end to end in a chain-like fashion to form the barrier system 100 as shown in FIG. 7. Each barrier unit 112 may be assembled as described above and then inserted into the ground with an end of one barrier unit 112 abutting an end of an adjacent barrier unit 112.

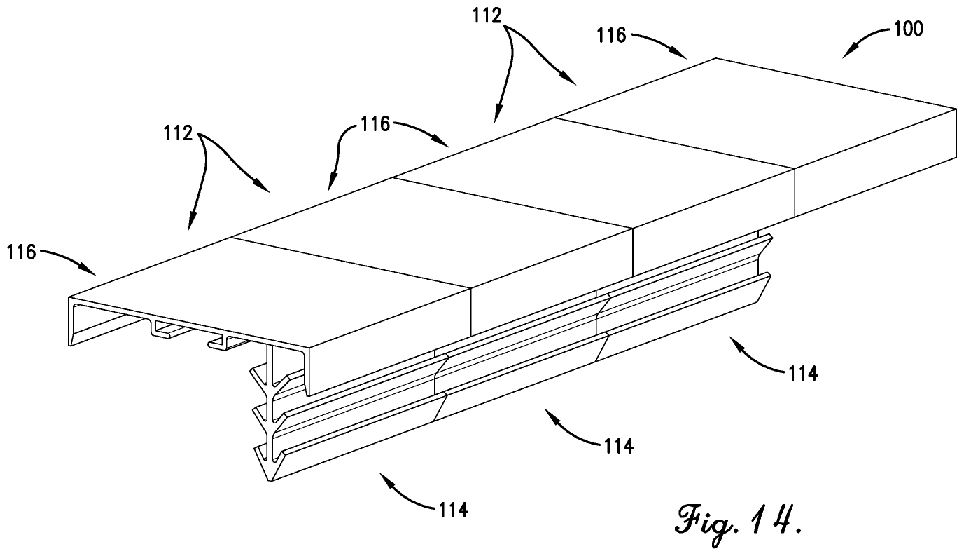

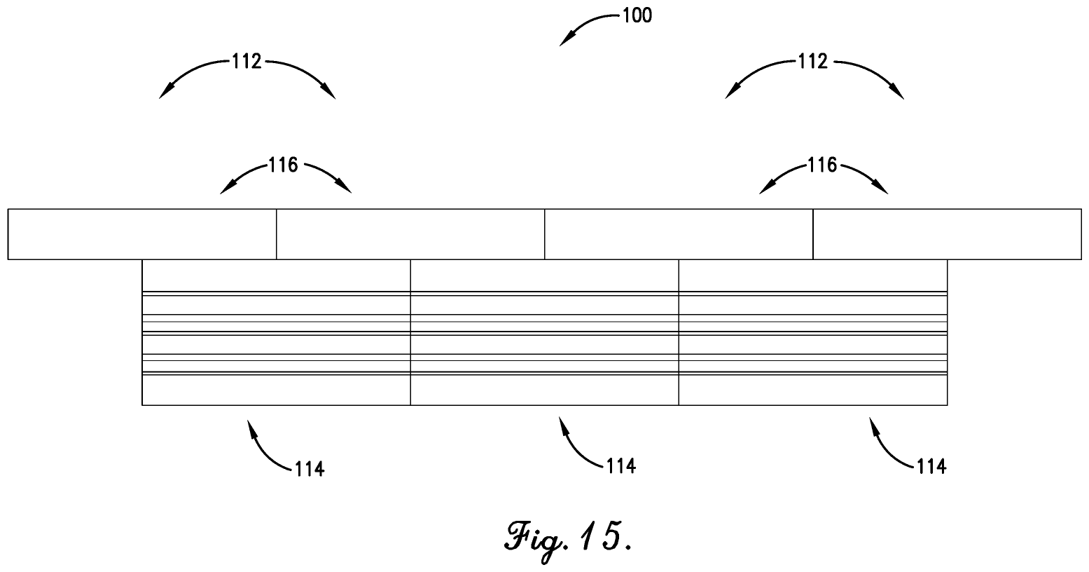

Alternatively, the barrier system 100 may be formed by offsetting the cover 116 from the stake 114 for each barrier unit 112 as shown in FIGS. 14 and 15. In various embodiments, there may be one more cover 116 than there are stakes 114 in the barrier system 100. Thus, there may be first and second spaced apart end covers 116 and a plurality of middle covers 116 positioned therebetween. The covers 116 are offset axially so that each end cover 116 covers or overlaps roughly half of one stake 114 only, and each middle cover 116 covers or overlaps roughly half of one stake 114 and roughly half of an adjacent stake 114.

Another embodiment of the barrier unit 212, shown in FIG. 16, includes a cap 218 and an anchor 220. The anchor 220 may function similarly to the anchor 120, while the cap 218 may function similarly to the combination of the cap 118 and the cover 116.

The cap 218 has a generally quadrilateral shape with an upper surface, an opposing lower surface, first and second opposing side surfaces, and first and second opposing end surfaces. At a lower edge of each side surface, the cap 218 may include a flange or beveled edge. Typically, the cap 218 is oriented on a horizontal plane.

The anchor 220 has a generally quadrilateral shape with an upper edge that is coupled to the cap 218 along a centerline of the lower surface of the cap 218. Thus, the anchor 220 is typically oriented along a vertical plane. The anchor 220 also has a lower edge, first and second opposing side surfaces positioned along its length, and first and second opposing end surfaces positioned along its height. In addition, the anchor 220 includes a plurality of side protrusions 222 distributed along the first and second side surfaces and extending outward therefrom. In exemplary embodiments, the side protrusions 222 includes a plurality of spikes pointing upward, spaced apart from one another along the height, and extending the length of the anchor 220. When viewed from one of the ends of the anchor 220, the spikes may form a sawtooth pattern on each side surface of the anchor 220.

The cap 218 and the anchor 220 of the barrier unit 212 may be integrally or monolithically formed, or the two components may be separately and joined together.

The barrier unit 212 may be utilized in a similar fashion as the barrier unit 112. That is, the barrier unit 212 may be installed by inserting the lower edge of the anchor 220 into the ground and pushing downward on the cap 218. The barrier unit 212 may be pushed into the ground until the lower edges of the side surfaces of the cap 218 penetrate the ground. A plurality of the barrier units 212 may be placed in the ground with an end of one barrier unit 212 abutting an end of an adjacent barrier unit 212.

### ADDITIONAL CONSIDERATIONS

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A barrier system to be installed on a ground surface for keeping unwanted vegetation from growing across a boundary, the barrier system comprising:
a first end stake, a second end stake, and a plurality of inner stakes, each stake including
a cap having a single roughly planar generally horizontally-oriented wall, and
a generally vertically-oriented anchor attached to the cap, the anchor configured to be inserted into the ground surface, the anchor including a plurality of side protrusions extending outward from the anchor for preventing upward migration of the barrier unit when the barrier unit is installed on the ground surface; and
a cover including
a generally horizontally-oriented top wall,
a channel positioned on a lower surface of the top wall, the channel including a first flange and a spaced apart second flange, each flange having a vertical member extending downward from the lower surface and a horizontal member attached to the vertical member and extending inward, the channel configured to receive the caps of the stakes,
a generally vertically-oriented first side wall attached to a first side edge of the top wall, and
a generally vertically-oriented second side wall attached to an opposing second side edge of the top wall, the first side wall and the second side wall each including a lower edge configured to penetrate the ground surface when the barrier unit is installed on the ground surface;
wherein the first end stake is configured to be positioned in the channel at a first end of the cover, the second end stake is configured to be positioned in the channel at a second end of the cover, and the inner stakes are configured to be positioned in the channel in between the first end of the cover and the second end of the cover.

21. The barrier system of claim 1, wherein the cap of each stake includes a downwardly-extending left flange and a downwardly-extending right flange, the left flange and the right flange each positioned on an opposing lengthwise edge of the wall.

22. The barrier system of claim 1, wherein the first side wall and the second side wall each include an upper edge that is connected to an opposing lengthwise outer edge of the top wall.
